(19) United States
(12) Patent Application Publication
(10) Pub. No.: US 2025/0383922 A1
(43) Pub. Date: Dec. 18, 2025

(54) TASK AND DATA ASSIGNMENT IN MULTI-CHIPLET PROCESSORS

(71) Applicant: ADVANCED MICRO DEVIVES , INC, Santa Clara, CA (US)

(72) Inventors: Mahmoud Khairy Abdelsadek Abdallah, Santa Clara, CA (US); Michael W. Boyer, Redmond, WA (US); Nuwan S. Jayasena, Santa Clara, CA (US); Sooraj Puthoor, Austin, TX (US)

(21) Appl. No.: 18/744,231

(22) Filed: Jun. 14, 2024

(51) Int. Cl. G06F 9/50; G06F 9/48; G06F 9/52

(52) U.S. Cl. CPC G06F 9/5027; G06F 9/4881; G06F 9/52

(57) ABSTRACT

Efficient task and data assignment is provided in multi-chiplet processors including one or more advanced processing chiplets (APCs). A graphics processing unit (GPU) assigns data for use by one or more tasks to memories associated with a plurality of APCs and one or more CPCs. A scheduler or other controller within or otherwise associated with the GPU assigns tasks, which utilize the assigned data, to the APCs. The GPU ensures efficient data assignment by adjustably interleaving data across memories associated with the APCs in order to limit off-chiplet remote memory traffic. Similarly, the scheduler ensures efficient task assignment by adjustably assigning tasks to the APCs, typically in the same order as or in a similar order to the placement order in which the data is assigned to the memories, in order to limit off-chiplet remote memory traffic.

### BACKGROUND

Parallel processors such as accelerator processors and graphics processing units (GPUs) conventionally implement graphics processing pipelines that concurrently process copies of commands that are retrieved from a command buffer. GPUs and other multithreaded processing units typically implement multiple processing elements (which may include processor cores, compute units, chiplets, or workgroup processors) that execute different programs or concurrently execute multiple instances of a single program on multiple data sets as a single “wave,” i.e., a group of threads running concurrently on a GPU. A hierarchical execution model is typically used to match the hierarchy implemented in hardware.

The execution model defines a kernel of instructions that are executed by one or more waves (also referred to as wavefronts, which may include one or more threads, streams, tasks, or work items). The graphics pipeline in a conventional GPU includes one or more shader engines that execute computer programs typically referred to as “shaders” using resources of the graphics pipeline such as compute units, memory, and caches. GPUs are traditionally used for graphical calculations, as implied by their name; however, in modern computing, shaders are often utilized as “compute shaders,” which function as general-purpose software that is able to perform work separately from a graphics processing pipeline. As GPU usage and machine learning applications have expanded over time, there is a necessity to improve the functionality and performance of GPUs.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system providing efficient task and data assignment in a multi-chiplet processor according to some implementations.

FIG. 2 is a block diagram illustrating an example of a multi-chiplet processor providing efficient task and data assignment according to some implementations.

FIG. 3 is a graph of an example of an efficient workgroup to processor assignment for a first workgroup type according to some implementations.

FIG. 4 is a graph of an example of an efficient workgroup to processor assignment for a second workgroup type according to some implementations.

FIG. 5 is a table illustrating an example of using counters to identify an efficient workgroup to processor assignment for a particular workgroup type according to some implementations.

FIG. 6 is a graph illustrating an example of modulating workgroup to processor assignment groupings to identify an efficient workgroup to processor assignment for a particular workgroup type according to some implementations.

FIG. 7 is a block diagram illustrating an example of using a memory interleaving granularity to identify an efficient workgroup to processor assignment for a particular workgroup type according to some implementations.

FIG. 8 is a table illustrating an example of an efficient workgroup to processor assignment for a third workgroup type according to some implementations.

FIG. 9 is a table illustrating an example of an efficient workgroup to processor assignment for a fourth workgroup type according to some implementations.

FIG. 10 is a flow diagram of a method of providing efficient task and data assignment in multi-chiplet processors according to some implementations.

### DETAILED DESCRIPTION

A parallel processor such as an accelerated processing device or graphics processing unit (GPU) typically includes a plurality of “shader engines,” where each shader engine includes a respective quantity of compute units, and a command processor coupled to the plurality of shader engines. The command processor receives one or more commands for execution and generates the plurality of workgroups or tasks (e.g., processing threads or collections of threads corresponding to one or more programs) based on the one or more commands. Assigning each workgroup to a respective shader engine may include dynamically assigning each workgroup to a respective shader engine via an interface such as a shader program interface (SPI), which acts as a scheduler, associated with the respective shader engine.

However, as GPU usage for executing compute shaders, machine learning applications, and other general-purpose applications has expanded over time, in order to provide a GPU with the flexibility to execute tasks related to a graphics processing pipeline, machine learning, or other advanced computing applications in an efficient manner, GPUs implemented in accordance with the teachings of the present disclosure include a plurality of advanced processing chiplets (APCs), also referred to as parallel processing chiplets (PPCs), which are configured to process tasks and function as advanced GPU chiplets in that they offer one or more of parallel processing functionality, optimized GPU functionality, and optimized processing for advanced applications that utilize, e.g., reduced precision data common in machine learning. The APCs are able to execute instructions separately or in parallel and, in some implementations, share a single pool of virtual and physical memory with extremely low latency.

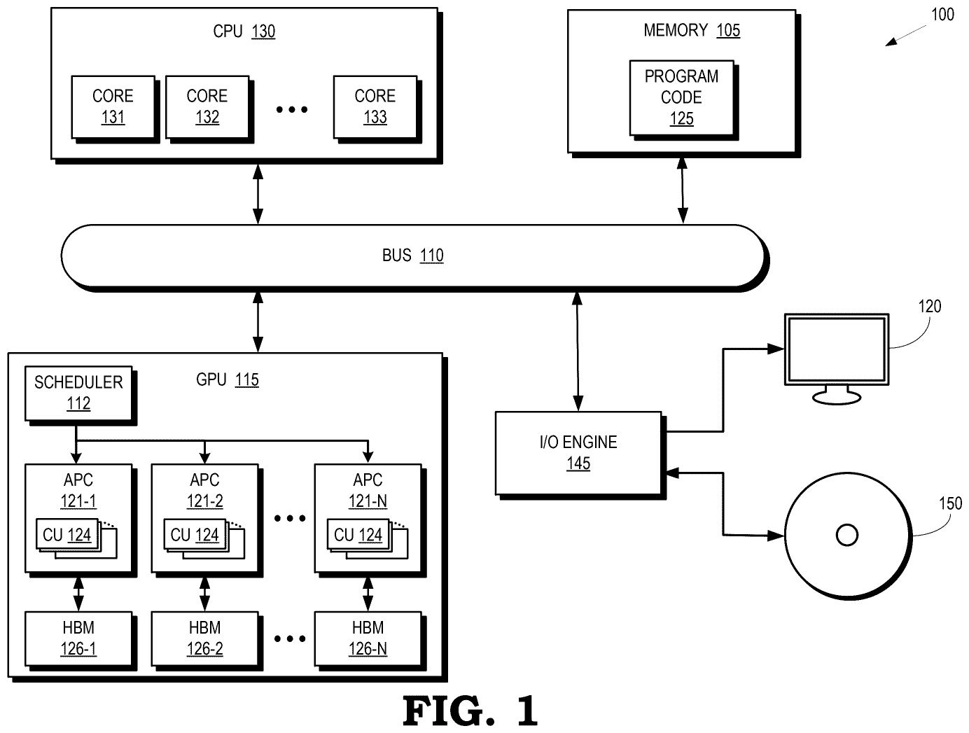

FIGS. 1-10 illustrate systems and techniques for providing efficient task and data assignment in multi-chiplet processors. As described in detail hereinbelow, a multi-chiplet processor or GPU assigns data for use by one or more tasks to a shared memory or memories associated with a plurality of APCs. A scheduler or other controller within or otherwise associated with the GPU assigns threads or groups of threads, also known as workgroups, which utilize the assigned data, to the APCs. Due to the less efficient performance of obtaining off-chiplet “remote” data (e.g., an APC accessing data stored in a memory having a relatively higher latency or access time, such as a memory associated with one or more other APCs) compared to the performance of reading on-chiplet “local” data (e.g., an APC accessing data stored in its own memory or its own relatively lower latency associated memory), which is typically more energy efficient than reading off-chiplet data, assignment of tasks to the APCs and/or data to memories associated with the APCs, should be optimized in order to minimize the necessity for APCs to access off-chiplet remote data. To provide this functionality, example implementations, apparatuses, and methods described hereinbelow provide efficient task and data assignment in multi-chiplet processors that include a plurality of APCs.

FIG. 1 is a block diagram of a processing system 100 providing efficient task and data assignment in a multi-chiplet processor according to some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The techniques described herein are, in different implementations, employed at any of a variety of parallel processors (e.g., vector processors, GPUs, general-purpose GPUs (GPGPUs), non-scalar processors, highly parallel processors, artificial intelligence (AI) processors, inference engines, machine learning processors, other multithreaded processing units, and the like). FIG. 1 illustrates an example of a multi-chiplet processor, which is implemented in the illustrated example as GPU 115, in accordance with some implementations. In some implementations, the GPU 115 renders images for presentation on a display 120. For example, the GPU 115 renders objects to produce values of pixels that are provided to the display 120, which uses the pixel values to display an image that represents the rendered objects. However, the GPU 115 is also capable of executing software not directly involved in any graphics processing pipeline, such as machine learning applications and other advanced computing applications.

In order to provide the GPU 115 with the flexibility to execute tasks related to a graphics processing pipeline, machine learning, or other advanced computing applications in an efficient manner, the GPU 115 includes a plurality of APCs, such as APCs 121-1, 121-2, and 121-N, which are configured to process tasks and function as advanced GPU chiplets in that they offer one or more of GPU functionality and optimized processing for advanced applications that utilize, e.g., reduced precision data common in machine learning. The APCs 121 are able to execute instructions separately or in parallel and, in some implementations, share a single pool of virtual and physical memory with extremely low latency. By providing the GPU 115 with a plurality of APCs 121, the GPU 115 is able to perform a number of tasks simultaneously while latency and data transfer energy between the APCs 121 is minimized. The APCs 121 are typically implemented using shared hardware resources of the GPU 115, such as compute units 124. In some implementations, the APCs 121 are used to implement shaders, such as geometry shaders, pixel shaders, and the like. Generally, the APCs 121 are a logical grouping of processing hardware, which in some implementations includes, e.g., one or more processing chiplets, cores, and/or caches. The APCs 121 typically include or access a number of compute units 124 in the GPU 115, and each of the compute units 124 typically includes a number of single-instruction-multiple-data (SIMD) units. The number of APCs 121 implemented in the GPU 115 is a matter of design choice and some implementations of the GPU 115 include more or fewer APCs than are shown in FIG. 1.

As shown in FIG. 1, the GPU 115 further includes a scheduler 112, which is implemented as any cooperating collection of hardware, software, or a combination thereof that performs functions and computations associated with assigning threads, workgroups, waves, or other tasks, such as compute shader threads, to one or more of the APCs 121. In some implementations, one or more of the APCs 121 are able to be selectively addressed or controlled independently from one another or addressed or controlled in groups of two or more such that the GPU 115, the scheduler 112, and/or a user is able to control which APCs 121 perform specific tasks or to distribute tasks across a number of APCs 121. In some implementations, the GPU 115 is used for general purpose computing. The GPU 115 executes instructions such as program code 125 stored in the memory 105 and the GPU 115 stores information in the memory 105 such as the results of the executed instructions.

As described further hereinbelow, in order to provide efficient task and data assignment in a multi-chiplet processor such as the GPU 115, the GPU 115 is configured to assign data associated with tasks to memories, e.g., high-bandwidth memories (HBMs) 126-1, 126-2, and 126-N, associated with, e.g., in close proximity to and/or sharing a chiplet with, a respective one of the plurality of APCs in a first assignment order, and the scheduler is configured to assign the tasks to the plurality of APCs in a second assignment order such that off-chiplet and/or remote data accesses are minimized. Although the GPU 115 or a related controller will typically assign data to the HBMs 126 and the scheduler 112 will typically assign tasks to the APCs 121, in some implementations, a user or program manually assigns data to the APCs 121 and tasks to the HBMs 126, either directly or via the scheduler 112, as desired for a particular scenario in which the user or program is optimized to utilize the GPU 115 in a particular configuration.

In some implementations, the processing system 100 also includes a CPU 130 that is connected to the bus 110 through which it communicates with the GPU 115 and the memory 105. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some implementations include more or fewer processor cores than are illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics or other processing by issuing draw calls or other tasks to the GPU 115.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the GPU 115, or the CPU 130. In the illustrated implementation, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the GPU 115 or the CPU 130.

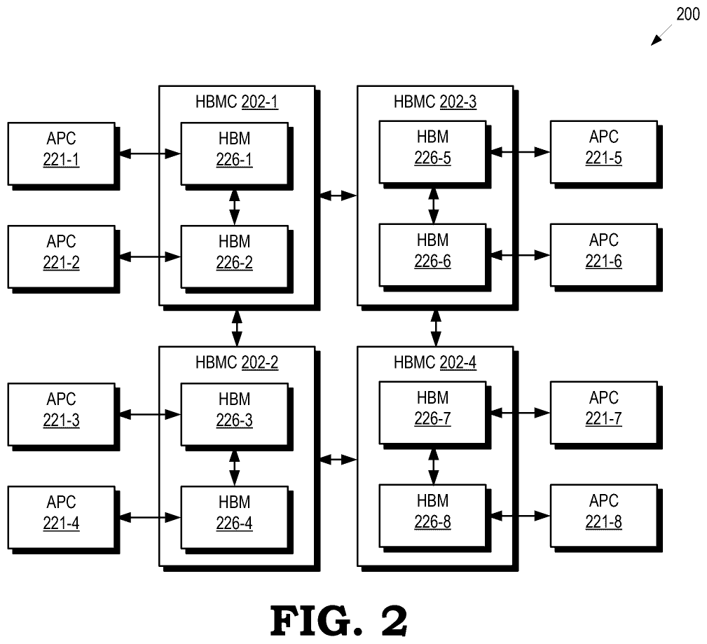

FIG. 2 is a block diagram 200 illustrating an example of a multi-chiplet processor providing efficient task and data assignment according to some implementations. For example, in a multi-chiplet GPU including APCs 221-1, 221-2, 221-3, 221-4, 221-5, 221-6, 221-7, and 221-8, in some implementations, the GPU ensures efficient data assignment by adjustably interleaving data across each of the HBMs 226-1, 226-2, 226-3, 226-4, 226-5, 226-6, 226-7, and 226-8 that are associated with the APCs 221. Once data is assigned to the HBMs 226, in some implementations, a scheduler such as scheduler 112 of FIG. 1 ensures efficient task assignment by adjustably assigning the tasks to the APCs 221, typically in the same order as or in a similar order to the order in which the data was assigned to the HBMs 226.

As shown in FIG. 2, in some implementations, HBMs 226 are grouped together in high-bandwidth memory chiplets (HBMCs), such as HBMC 202-1, 202-2, 202-3, 202-4, which in some implementations include one or more APCs 221. For example, in FIG. 2, a pair of HBMs 226-1 and 226-2 are grouped together in HBMC 202-1, although in other implementations more than two HBMs 226 are grouped in a single HBMC. In some implementations, communication such as data accesses by an APC, such as APC 221-1, is faster and more energy efficient with an associated HBM, such as HBM 226-1, than with a non-associated HBM, such as HBM 226-2 or HBM 226-3. However, in some implementations, HBMs such as HBMs 226-1 and 226-2 contained within an associated HBMC, such as the HBMC 202-1 associated with APCs 221-1 and 221-2, provide similar or equivalent access speed and energy efficiency when accessed by the APCs associated with the HBMC compared to other non-associated HBMs in non-associated HBMCs, such as HBM 226-3 in HBMC 202-2.

Notably, in this disclosure, the terms “order” or “assignment order” do not necessarily refer to a sequence in time but rather an order, or pattern, of assignments relative to the particular components. Accordingly, although, for example, data may be assigned to HBM 226-3 prior to data being assigned to HBM 226-4 while a task may be assigned to APC 221-4 prior to a task being assigned to APC 221-3, the “order” of the assignments of the data, in the context of this disclosure, would still match or correspond to the “order” or “pattern” of the assignments of the tasks in the example of diagram 200, if the data assigned to HBM 226-3 corresponds to the task assigned to APC 221-3 and the data assigned to HBM 226-4 corresponds to the task assigned to APC 221-4. In other words, the “order” as described herein is analogous to the “pattern” of assignments relative to the components rather than the particular timing of the assignments. In some implementations, the data and the tasks are assigned in a round robin assignment order such that each HBM 226 is sequentially assigned data and each APC 221 is sequentially assigned a task in a predetermined order before new data and new tasks are repeatedly assigned to the HBMs 226 and APCs 221 in the same predetermined order, although other assignment orders are usable in other implementations.

By assigning tasks and data in the same order across the APCs 221 and HBMs 226, the tasks and data associated with those tasks are assigned to a corresponding set of APC and HBM, e.g., APC 221-1 and HBM 226-1. Although, as indicated by the arrows in FIG. 2, the APCs 221 are capable of communicating between and among each other and of accessing data stored in any HBM associated with any APC, as noted above, in some implementations, corresponding sets of APCs and HBMs, such as APC 221-1 and HBM 226-1, are able to utilize on-chiplet local traffic and thus require lower energy per bit (and so are relatively more energy efficient than other HBMs 226) and/or provide lower latency compared to off-chiplet remote traffic, such as would be required if, for example, data were assigned to HBM 226-1 to be accessed by a task assigned to APC 221-2 or 221-3. Accordingly, assigning the data and the tasks in the same or a similar order across the APCs 221 and HBMs 226 ensures efficient task and data assignment in a multi-chiplet processor like that illustrated in diagram 200.

As noted above, in a multi-chiplet GPU including APCs 221, in some implementations, the GPU ensures efficient data assignment by adjustably interleaving data across each of the HBMs 226 that are associated with the APCs 221. Once data is assigned to the HBMs 226, in some implementations, a scheduler similar to scheduler 112 of FIG. 1 ensures efficient task assignment by adjustably assigning tasks to the APCs 221 and/or interleaving the tasks across the APCs 221, typically in the same order as or in a similar order to the order in which the data was assigned to the HBMs 226. Although configurable data assignment and configurable task assignment are both possible in some GPUs, in other GPUs, only one is possible. For example, in some GPUs, data assignment is predetermined and not adjustable while task assignment is configurable, while in other GPUs, task assignment is predetermined and not adjustable while data assignment is configurable. Accordingly, various implementations described hereinbelow address configurable task assignment and configurable data assignment separately, although both configurable task assignment and configurable data assignment are possible in some implementations.

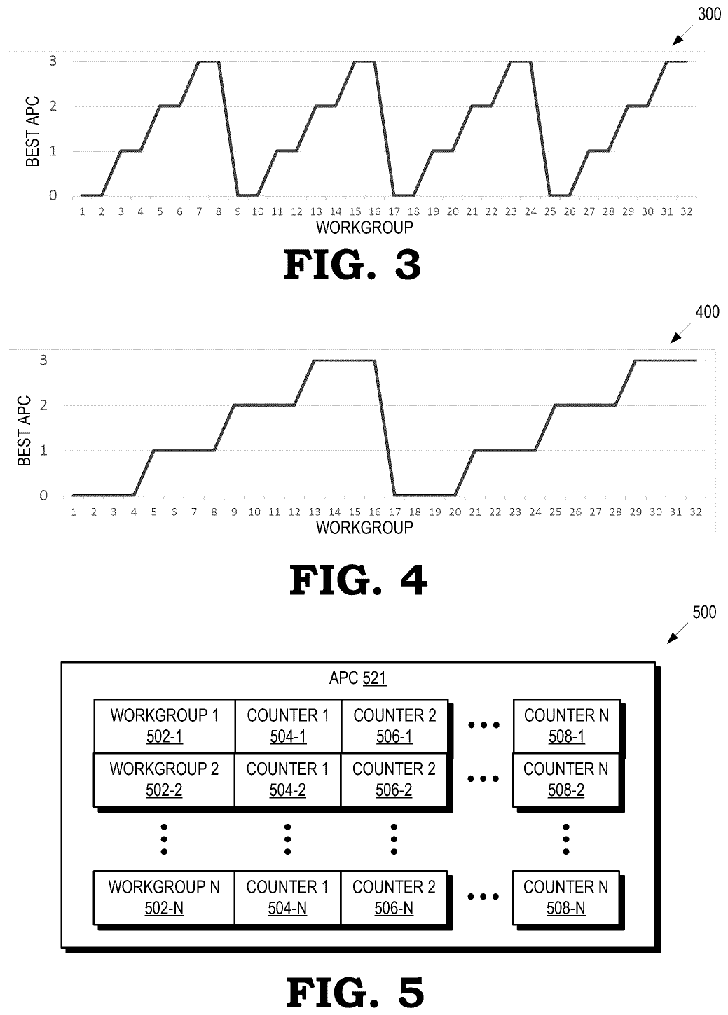

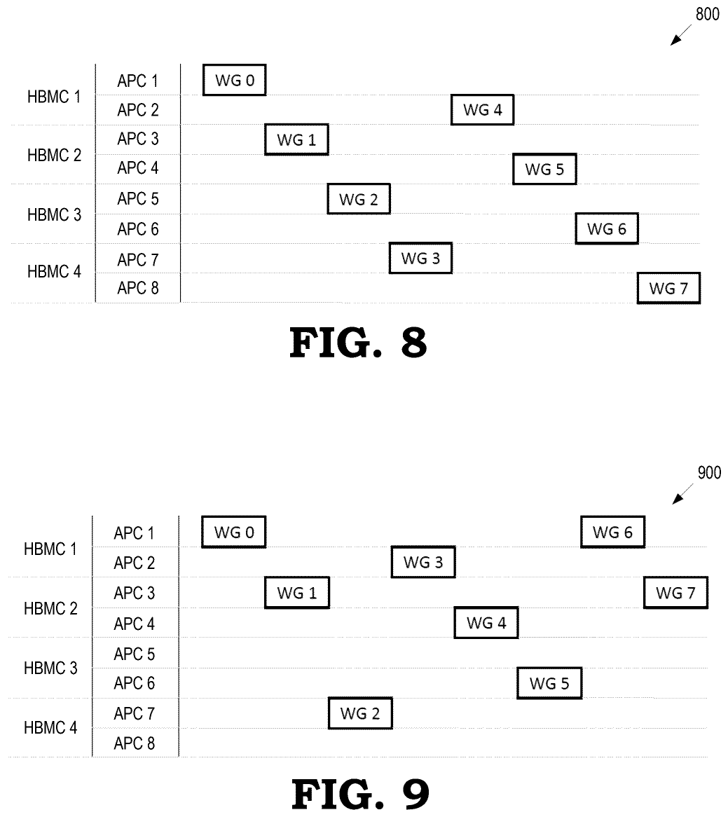

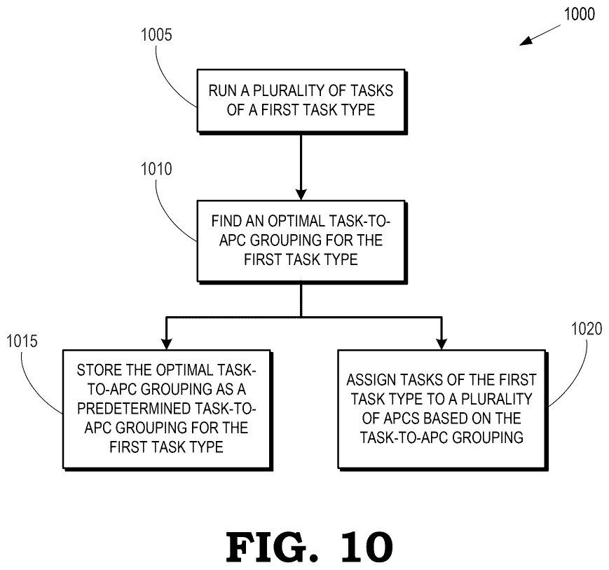

The examples of FIGS. 3-9 described hereinbelow are related primarily to GPUs with configurable task assignment but static memory interleaving granularities (i.e., the amount of data assigned to each memory is not adjustable). Data assignment is static in the examples of FIGS. 3-9 such that, for example, 4 kilobytes (KB) of data are assigned to each HBMC 202 in a round robin fashion such that 4 KB are assigned to HBMC 202-1, then 4 KB are assigned to HBMC 202-2, then 4 KB are assigned to HBMC 202-3, and finally 4 KB are assigned to HBMC 202-4, before the pattern repeats and another 4 KB are assigned to HBMC 202-1, another 4 KB are assigned to HBMC 202-2, and so on, although it is noted that in other implementations different orders than round robin and/or different memory interleaving granularities than 4 KB are possible. Because the data assignment is static in the examples of FIGS. 3-9, task assignment should be optimized to limit the need for APCs 221 to access off-chiplet and/or remote data. One way to achieve this is to allow a user to specify which tasks should be assigned to which APCs 221; however, it can be difficult for a user to determine optimal task assignment for particular types of tasks (e.g., different functions or kernels). Accordingly, FIGS. 3-9 provide examples of how task assignment is automated in some implementations. FIGS. 3-7 are directed to identifying a task-to-APC grouping for each of different types of tasks such that, in some implementations, tasks are assigned to APCs 221 based on a predetermined task-to-APC grouping, while FIGS. 8 and 9 are more generally directed to assigning tasks to APCs 221 based on memory requirements of each task for different types of tasks.

FIG. 3 is a graph 300 of an example of an efficient workgroup to processor assignment for a first workgroup type according to some implementations, while FIG. 4 is a graph 400 of an example of an efficient workgroup to processor assignment for a second workgroup type according to some implementations. Generally, the y-axis of the graphs 300 and 400 identifies the best APC 221 onto which each workgroup or task on the x-axis should be assigned in order to minimize remote memory traffic. In order to generate the graphs 300 and 400, a scheduler such as the scheduler 112 of FIG. 1 applies round robin task scheduling for a number of tasks identified as workgroups 1-32 in FIGS. 3 and 4. After the tasks finish execution or have executed for an amount of time sufficient to gain confidence in the observed profiling information, the best APC 221 for each task is identified based on which APC 221 requires the least off-chiplet remote traffic for each task. For example, in some implementations, the predetermined (after the profiling is complete and prior to runtime) task-to-APC grouping for the first task type is identified based on a counter value, e.g., a minimum counter value, of one or more of a plurality of counters that track off-chiplet and/or remote traffic for particular APCs 221 and/or tasks. In some implementations, the amount of time sufficient to gain confidence in the observed profiling information is predetermined and in other implementations, the amount of time is determined by the point at which a threshold statistical measure identifying a confidence in the observed profiling information is met.

For example, as shown in FIG. 3 for the first type of task, the first two tasks or workgroups require the least off-chiplet remote traffic when assigned to APC 0, while tasks 3 and 4 require the least off-chiplet remote traffic when assigned to APC 1, and so on. In contrast, as shown in FIG. 3 for the second type of task, the first four tasks or workgroups require the least off-chiplet remote traffic when assigned to APC 0, while tasks 5-8 require the least off-chiplet remote traffic when assigned to APC 1, and so on. As the graphs 300 and 400 are both periodic, it is possible to identify a predetermined task-to-APC grouping for each type of task that will ensure efficient task assignment when tasks are assigned to a plurality of APCs based on the predetermined task-to-APC grouping for each of the different types of tasks. For example, as shown in FIG. 3, two tasks are assigned to each of the APCs before repeatedly assigning two more tasks to each of the APCs, and so on, and so an optimal predetermined task-to-APC grouping for the first type of task profiled in FIG. 3 would be two. However, as shown in FIG. 3, four tasks are assigned to each of the APCs before repeatedly assigning four more tasks to each of the APCs, and so on, and so an optimal predetermined task-to-APC grouping for the second type of task profiled in FIG. 4 would be four. After determining optimal predetermined task-to-APC groupings for different types of tasks, in some implementations, the predetermined task-to-APC groupings are stored in, e.g., GPU 115 and/or memory 105, for example in the form of a table, a kernel binary, a kernel header, or other data structure, such that the predetermined task-to-APC grouping for each of the different types of tasks indicates a number of tasks to be assigned to each APC for each of the different types of tasks, and the predetermined task-to-APC groupings are utilized for subsequent executions of the different types of tasks.

FIG. 5 is a table 500 illustrating an example of using counters to identify an efficient workgroup to processor assignment for a particular workgroup type according to some implementations. Although counters are generally useful for performing determinations of predetermined task-to-APC groupings like those described above with reference to FIGS. 3 and 4, such as to count numbers of off-chiplet remote memory requests initiated by each APC 221 and/or task, FIG. 5 relates primarily to an implementation where task-to-APC groupings are not predetermined or are determined at runtime. In such an implementation, an APC 221 such as APC 521 includes a table 500 or other data structure(s) that tracks a number of off-chiplet remote memory requests initiated by each APC 221 and/or task. For example, for a particular type of task, the table 500 in the APC 521 tracks each task or workgroup 502-1, 502-2, and 502-N separately.

At runtime for a particular type of task, after resetting each of the counters to zero, each time the task or workgroup 502-1 initiates an off-chiplet and/or remote memory request, the APC 521 increments a counter corresponding to that particular memory. For example, in some implementations, counter 1 504-1 corresponds to a first remote HBM, counter 2 506-1 corresponds to a second remote HBM, and counter N 508-1 corresponds to a third remote HBM. Similarly, each time the workgroup 502-2 initiates an off-chiplet and/or remote memory request, the APC 521 increments a counter corresponding to that particular memory, such as counter 1 504-2, counter 2 506-2, and counter N 508-2. Again similarly, each time the workgroup 502-N initiates an off-chiplet and/or remote memory request, the APC 521 increments a counter corresponding to that particular memory, such as counter 1 504-N, counter 2 506-N, and counter N 508-N. Next, in some implementations, a graph similar to the examples of FIGS. 3 and 4 is generated and an optimal APC for executing each task is determined. That is, after a scheduler such as the scheduler 112 of FIG. 1 applies round robin task scheduling for a number of tasks identified as workgroups 502 in FIG. 5 and the tasks finish execution or have executed for an amount of time sufficient to gain confidence in the observed profiling information, the APC 521 and/or GPU 115 determines which APC requires the least off-chiplet remote traffic for each task or workgroup 502.

In some implementations, the APC 521 determines which tasks it can run most efficiently and selects those tasks independently from a scheduler or other APCs. However, in some implementations, the GPU 115 analyzes the counters 504, 506, 508 in each APC, such as APC 521, to identify which tasks should be assigned to each APC. If a pattern is identified in the order in which tasks should be assigned to each APC for one or more types of tasks, in some implementations, the predetermined task-to-APC groupings are stored in, e.g., GPU 115 and/or memory 105, for example in the form of a table, a kernel binary, a kernel header, or other data structure, and the predetermined task-to-APC groupings are utilized for subsequent executions of the different types of tasks. Accordingly, although predetermined task-to-APC groupings can be identified ab initio using profiling like that described above with reference to FIGS. 3 and 4, which is performed in some implementations using a compiler, task type profiling is also possible at runtime in an “online” manner, e.g., using a table like table 500. Online profiling is particularly useful in implementations where types of tasks are modifiable or configurable, while ab initio profiling is particularly useful in implementations where types of tasks remain static (e.g., for tasks in hardware instruction sets).

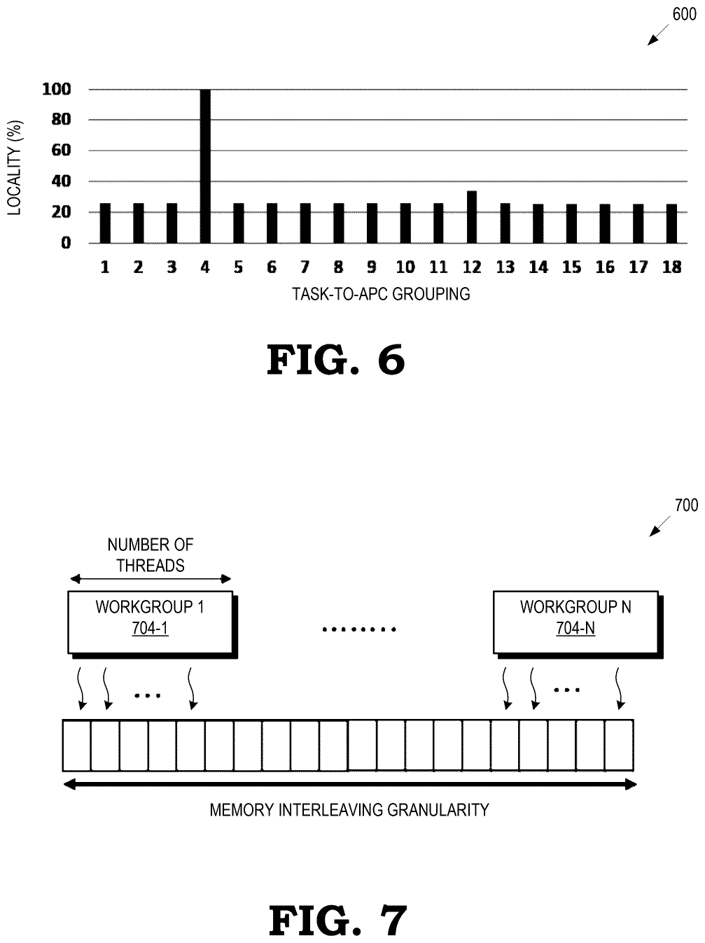

FIG. 6 is a graph 600 illustrating an example of modulating workgroup to processor, i.e., task-to-APC, assignment groupings to identify an efficient task-to-APC assignment for a particular workgroup type according to some implementations. In this example, which is performed in an ab initio manner, performed in some implementations using a compiler, or in an online manner at runtime in different implementations, a number of different task-to-APC groupings are used to identify one or more optimal task-to-APC groupings. For example, as shown in FIG. 6, task-to-APC groupings of one task per APC 221, two tasks per APC 221, three tasks per APC 221, and so on are utilized and a locality percentage is calculated for each based on the percentage of local memory requests compared to the total amount of memory requests, including off-chiplet and/or remote memory requests. As shown in FIG. 6, for the type of task profiled by the graph 600, a task-to-APC grouping of four exhibits the highest locality percentage (100%) and so is an optimal task-to-APC grouping for this type of task.

FIG. 7 is a block diagram 700 illustrating an example of using a memory interleaving granularity to identify an efficient workgroup to processor assignment for a particular workgroup type according to some implementations. As noted above, in some implementations, data is interleaved over the HBMs 226 with a static memory interleaving granularity. For any given APC 221, in order to minimize off-chiplet remote traffic, the data accessed per task or workgroup assigned to this APC 221 should match the data interleaving granularity. Equation 1 below provides an example of how to identify an optimal task-to-APC grouping that will ensure such a correspondence by dividing the memory interleaving granularity by the product of a number of threads per task and the amount of memory used per thread.

$$optimal task - to - APC grouping = \frac{memory interleaving granularity}{threads per task \times memory per thread} \qquad ( 1 )$$

For example, if the number of threads in each task or workgroup 704-1, 704-N is 256 and each thread accesses one float element having a size of 4 bytes, the data accessed per workgroup is 1 KB (256×4). If the hardware interleaving granularity is 8 KB, then in this example the optimal task-to-APC grouping is eight (8 KB÷1 KB). Accordingly, in some implementations, a predetermined task-to-APC grouping for a particular task type is based on a memory interleaving granularity associated with a multi-chiplet processor. Further, in some implementations, a predetermined task-to-APC grouping for a particular task type is based on a ratio of the memory interleaving granularity to an amount of memory used by each task of the first task type. As shown in Equation 1, in some implementations, a predetermined task-to-APC grouping for a particular task type is based on a number of threads for each task of the first task type and an amount of memory used by each of the threads.

As noted above, FIGS. 8 and 9 are more generally directed to assigning tasks to APCs 221 based on memory requirements of each task for different types of tasks. For example, in some implementations, when memory requirements for each task make predetermined task-to-APC groupings difficult or impossible to identify, a static task assignment methodology or numerically determined assignment methodology provides efficient task and data assignment. FIG. 8 is a table 800 illustrating an example of an efficient workgroup to processor (i.e., task-to-APC) assignment for a particular workgroup type according to some implementations. In some implementations, an optimal task-to-HBMC grouping is provided by a user or otherwise determined using methods similar to those described above for determining an optimal task-to-APC grouping. In some implementations, if the task-to-HBMC grouping is an even number, the task-to-APC grouping is determined by halving the task-to-HBMC grouping. However, in some implementations, when the task-to-HBMC grouping is an odd number, an interleaved task-to-APC grouping is used such as that shown in FIG. 8. In this example, a first task or workgroup is assigned to APC 1, a second workgroup is assigned to APC 3, a third workgroup is assigned to APC 5, a fourth workgroup is assigned to APC 7, a fifth workgroup is assigned to APC 2, and so on.

FIG. 9 is a table 900 illustrating an example of an efficient workgroup to processor (i.e., task-to-APC) assignment for a different workgroup type from that of FIG. 8 according to some implementations. In this example, the optimal task-to-HBMC grouping, which is again provided by a user or otherwise determined using methods similar to those described above for determining an optimal task-to-APC grouping, is a non-integer number, and, as a consequence of there being two APCs per HBMC in this example, the task-to-APC grouping is also a non-integer number. In the case of a non-integer optimal task-to-HBMC grouping, in some implementations, an interleaved task-to-APC grouping such as that shown in FIG. 8 is modified based on the memory use of each task. In the example of FIG. 9, each task uses 5 KB of contiguous data and the memory interleaving granularity, i.e., the amount of memory assigned to each HBMC, is 4 KB. Accordingly, the optimal task-to-HBMC grouping in this example is 0.8 (memory interleaving granularity divided by per-workgroup access size).

In order to minimize off-chiplet remote memory accesses, the tasks should be assigned to the APCs such that most of the memory they utilize will be local to their associated HBM or HBMC. In order to ensure this is the case, in some implementations, an algorithm executed by, e.g., the scheduler 112, the GPU 115, the CPU 130, profiling hardware or software, or a compiler is used to determine an optimal task-to-APC assignment that skips an assignment any time less than half of the memory of a given HBMC is available or less than one full HBM is available for the task to be assigned. For example, as shown in FIG. 9, similar to FIG. 8, workgroup 0 is assigned to APC 1. Due to static data interleaving, 80% of the data for workgroup 0 (4 KB) is stored of the memory of HBMC 1 and 20% (1 KB) is stored in the memory of HBMC 2 by workgroup 0 (the optimal task-to-HBMC grouping for this task type is 0.8 because only 80% of the data for this task fits into any one HBMC).

Next, as in FIG. 8, workgroup 1 is assigned to APC 3. However, in this case, only 60% of the data (3 KB) for workgroup 1 will be stored in HBMC 2, as 1 KB of HBMC 2 is used to store data for workgroup 0, and so 40% or 2 KB of the data for workgroup 1 will be stored in HBMC 3. Next, again as in FIG. 8, workgroup 2 will be attempted to be assigned to APC 5. However, as only 2 KB of HBMC 3 remains and so less than 50% of the data for workgroup 2 (40% of the data or 2 KB) will be stored in HBMC 3, the algorithm skips APC 5 and instead proceeds to attempt to assign workgroup 2 to APC 7. As 60% of the data (3 KB) for workgroup 2 will be stored in HBMC 4, the algorithm proceeds to assign workgroup 2 to APC 7. Thus, in some implementations, anytime less than half of the data for a task or workgroup is stored in a given HBMC, the algorithm skips an assignment corresponding to that HBMC.

In a general case, in some implementations, a variable L is initialized to 0 and a variable C is set to the optimal task-to-HBMC grouping by the scheduler 112, the GPU 115, the CPU 130, profiling hardware or software, or a compiler, depending on the particular implementation. For each attempted assignment to an APC, C is added to L. If the sum of C and L is greater than 0.5, indicating that half or more of the data for a particular workgroup is located in a given HBMC, the sum is rounded to the nearest integer and a number of tasks or workgroups corresponding to that nearest integer is assigned to the current APC. However, if the sum of C and L is less than 0.5, the current APC is skipped. Whether one or more tasks are assigned or the APC is skipped, L is decremented by the nearest integer to the sum of C and L, thus storing the leftover, non-integer portion of data for a particular workgroup that remains to be assigned, and the algorithm proceeds to the next APC in the interleaved task-to-APC grouping order of FIG. 8. As L represents the leftover portion of data for a particular workgroup, if there is free space leftover in the previous HBMC, L is negative in a current task assignment iteration; however, if a portion of the data for a particular workgroup needs to be stored in the current HBMC for a current task assignment iteration, then L is positive. It is noted that in some implementations, a different grouping order than that shown in FIG. 8 is used, and, in some implementations, a user specifies an amount of contiguous data accessed by each task, a task-to-HBMC or task-to-APC grouping, or a task-to-memory-address grouping (e.g., based on profiling tools or compiler data), and a task-to-APC grouping is determined as a function of the user specified information, e.g., using one or more of the above-specified methodologies.

In some implementations, GPUs have static task assignment but configurable memory interleaving granularities (i.e., the amount of data assigned to each memory is adjustable or virtual memory pages are freely assignable to different HBMCs). In these situations, in some implementations, a user or profiling tool specifies a number of contiguous memory pages accessed by each task and the scheduler 112, the GPU 115, the CPU 130, profiling hardware or software, or a compiler sets a value for a number of virtual memory pages to be allocated to a particular HBM or HBMC based on the specified number. For example, for a task or workgroup with 256 threads where each thread accesses 8 bytes, the task accesses 2 KB (8×256) of memory. If the GPU has static task assignment and, e.g., a task-to-APC or task-to-HBMC grouping of 24, then each grouping accesses 48 KB of memory. If the GPU has a page size of 4 KB, then each grouping accesses 12 (48 KB÷4 KB) pages. Accordingly, in this example, the first 12 pages should be allocated on the first HBMC in a given task assignment order. Notably, in some implementations, if the number of pages accessed by each task-to-APC or task-to-HBMC grouping is a non-integer number, either a similar algorithm to that described above in connection with FIG. 9 is used or the grouping size is adjusted upward or downward such that the number of pages accessed by the grouping is an integer number. Additionally, in some implementations, a user specifies an explicit page-to-HBMC or page-to-HBM assignment for one or more virtual memory pages (e.g., based on profiling tools or compiler data).

In some implementations, in order to ensure a predictable and consistent memory interleaving along with round-robin task scheduling, tasks and allocated memory for a task should physically assignments with a first or same chiplet, e.g., APC 221-1, and its associated memory, e.g., HBM 226-1. For systems with power-of-two numbers of chiplets and a power-of-two memory interleaving granularity, this condition (i.e., starting from the first chiplet) is implicitly fulfilled if the runtime ensures assigned physical pages for each new memory assignment are aligned to the physical page size. For systems with power-of-two numbers of APCs 221 and data accessed per task having power-of-two numbers of bytes, task assignment starts from HBM 226-1 or HBMC 202-1 with each new page if the scheduler starts scheduling each task from the first chiplet, e.g., APC 221-1.

FIG. 10 is a flow diagram of a method 1000 of providing efficient task and data assignment in multi-chiplet processors according to some implementations. In some implementations, the method 1000 is executed by one or both of the GPU 115 and the scheduler 112 of the processing system 100 of FIG. 1. The method 1000 is usable to execute a plurality of tasks of a first task type and identify a task-to-APC grouping for the first task type based on the executing. Then the method 1000 is usable to store the identified task-to-APC grouping as a predetermined task-to-APC grouping for the first task type and/or assign tasks of the first task type to a plurality of APCs based on the identified task-to-APC grouping. Generally, the method is usable to assign tasks to a plurality of APCs based on a predetermined task-to-APC grouping for each of a plurality of different types of tasks. At block 1005 of the method 1000, a multi-chiplet processor, GPU, or a controller (such as the scheduler 112) in a multi-chiplet processor or GPU, such as the GPU 115 of FIG. 1, runs a plurality of tasks of a first task type at a number of APCs, such as APCs 221 of FIG. 2. At block 1010, the method 1000 includes finding an optimal task-to-APC grouping for the first task type, e.g., using a scheduler such as the scheduler 112, a GPU such as the GPU 115, a CPU such as the CPU 130, profiling hardware or software, or a compiler, using one or more of the methodologies described hereinabove. At block 1015, the method 1000 includes storing the optimal task-to-APC grouping as a predetermined task-to-APC grouping for the first task type. Additionally or alternatively, at block 1020, the method 1000 includes assigning tasks of the first task type to a plurality of APCs based on the identified task-to-APC grouping, e.g., using a scheduler such as the scheduler 112 or a GPU such as the GPU 115.

As described hereinabove, in some implementations, the method 1000 includes using a plurality of counters, such as the counters of FIG. 5, to track a number of accesses to a plurality of memories associated with the plurality of APCs by the first task type. In some implementations, the method 1000 includes identifying the task-to-APC grouping for the first task type based on a counter value of one or more of the plurality of counters. In some implementations, the method 1000 includes assigning tasks for a first task type of the different types of tasks based on a number of tasks indicated by the task-to-APC grouping for the first task type. In some implementations, the method 1000 includes assigning the tasks for the first task type based on a memory interleaving granularity associated with the multi-chiplet processor, as described above in connection with FIG. 7. In some implementations, the method 1000 includes assigning the tasks for the first task type based on a ratio of the memory interleaving granularity to an amount of memory used by each task of the first task type, as described above in connection with FIG. 7. In some implementations, the method 1000 includes assigning the tasks for the first task type based on a number of threads for each task of the first task type and an amount of memory used by each of the threads, as described above in connection with FIG. 7. In some implementations, as described hereinabove, the different types of tasks comprise different functions or kernels. In some implementations, as described hereinabove, the tasks comprise workgroups or threads.

In some implementations, the apparatuses and techniques described above are implemented in a system including one or more integrated circuit (IC) devices (also referred to as integrated circuit packages or microchips), such as the GPU 115, the APCs 121 and 521, the scheduler 112, the HBMs 126 and 226, the HBMCs 202, and the method 1000 described above. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An apparatus comprising:
a multi-chiplet processor comprising:
a plurality of parallel processing chiplets (PPCs) to process a plurality of different types of tasks; and
a scheduler to assign the tasks to the plurality of PPCs based on a predetermined task-to-PPC grouping for each of the different types of tasks.

2. The apparatus of claim 1, wherein the predetermined task-to-PPC grouping is based on a latency or energy efficiency of one or more memories associated with the plurality of PPCs for each of the different types of tasks.

3. The apparatus of claim 1, wherein the predetermined task-to-PPC grouping for each of the different types of tasks indicates a number of tasks to be assigned to each PPC for each of the different types of tasks.

4. The apparatus of claim 3, wherein a predetermined task-to-PPC grouping for a first task type of the different types of tasks is based on a memory interleaving granularity associated with the multi-chiplet processor.

5. The apparatus of claim 4, wherein the predetermined task-to-PPC grouping for the first task type is further based on a ratio of the memory interleaving granularity to an amount of memory used by each task of the first task type.

6. The apparatus of claim 4, wherein the predetermined task-to-PPC grouping for the first task type is further based on a number of threads for each task of the first task type and an amount of memory used by each of the threads.

7. The apparatus of claim 3, wherein a predetermined task-to-PPC grouping for a first task type of the different types of tasks is a non-integer number.

8. The apparatus of claim 1, further comprising a plurality of counters that track a number of accesses to a plurality of memories associated with the plurality of PPCs by a first task type of the different types of tasks to identify the predetermined task-to-PPC grouping for the first task type.

9. The apparatus of claim 1, wherein the different types of tasks comprise different functions or kernels.

10. A method of assigning tasks in a multi-chiplet processor including a plurality of parallel processing chiplets (PPCs), comprising:
assigning the tasks to the plurality of PPCs based on a predetermined task-to-PPC grouping for each of a plurality of different types of tasks.

11. The method of claim 10, further comprising identifying the task-to-PPC grouping based on a latency or energy efficiency of one or more memories associated with the plurality of PPCs for each of the different types of tasks.

12. The method of claim 11, further comprising, for a first task type of the different types of tasks:
executing a plurality of tasks of the first task type;
identifying the task-to-PPC grouping for the first task type based on the executing; and
storing the identified task-to-PPC grouping as the predetermined task-to-PPC grouping for the first task type.

13. The method of claim 12, wherein the identifying includes using a plurality of counters to track a number of accesses to a plurality of memories associated with the plurality of PPCs by the first task type.

14. The method of claim 10, further comprising assigning tasks for a first task type of the different types of tasks based on a number of tasks indicated by the task-to-PPC grouping for the first task type.

15. The method of claim 14, further comprising assigning the tasks for the first task type based on a memory interleaving granularity associated with the multi-chiplet processor.

16. The method of claim 15, further comprising assigning the tasks for the first task type based on a ratio of the memory interleaving granularity to an amount of memory used by each task of the first task type.

17. The method of claim 15, further comprising assigning the tasks for the first task type based on a number of threads for each task of the first task type and an amount of memory used by each of the threads.

18. An apparatus comprising:
a multi-chiplet processor comprising:
a plurality of parallel processing chiplets (PPCs) to process a plurality of different types of tasks;
one or more memories associated with the plurality of PPCs; and
a scheduler to assign the tasks to the plurality of PPCs based on a latency or energy efficiency of the one or more memories for each of the different types of tasks.

19. The apparatus of claim 18, wherein the scheduler is to assign the tasks to the plurality of PPCs based on a predetermined task-to-PPC grouping for each of the different types of tasks.

20. The apparatus of claim 19, wherein the predetermined task-to-PPC grouping for each of the different types of tasks indicates a number of tasks to be assigned to each PPC for each of the different types of tasks.
